(19) United States
(12) Patent Application Publication
(10) Pub. No.: US 2025/0291135 A1
(43) Pub. Date: Sep. 18, 2025

(54) OPTICAL INTERCONNECTS AND RELATED METHODS

(71) Applicant: Intel Corporation, Santa Clara, CA (US)

(72) Inventors: Frank F. Wu, San Jose, CA (US); Archana Ashok, Los Gatos, CA (US); Suohai Mei, Los Gatos, CA (US); Xiaoyu Hong, Fremont, CA (US)

(21) Appl. No.: 18/606,747

(22) Filed: Mar. 15, 2024

(51) Int. Cl. G02B 6/42

(52) U.S. Cl. CPC G02B 6/4243

(57) ABSTRACT

Optical interconnections and related methods are disclosed herein. An optical interconnect disclosed herein includes an optical component carrier including first grooves, the optical component carrier including an optical component including a first end, and a waveguide carrier including second grooves engaged with the first grooves, the first grooves complimentary with the second grooves, the waveguide carrier including a waveguide in a corresponding one of the second grooves, the waveguide including a second end aligned with the first end.

### FIELD OF THE DISCLOSURE

This disclosure relates generally to fiber optics and, more particularly, to optical interconnects and related methods.

### BACKGROUND

Optical interconnects facilitate the transmission of signals from one portion of an electronic device to another electronic device. Optical interconnects use waveguides, such as fiber optics, to channel light from a light emitter to a light detector. Electrical interconnects have comparatively lower latency and power consumption than electrical interconnects. The use of optical interconnects enables power-efficient and low-latency communications.

### BRIEF DESCRIPTION OF THE DRAWINGS

FIG. 1 is a perspective view of an example system including an example interconnect between an example photonic integrated circuit including an optical component carrier and an example waveguide carrier implemented in accordance with teachings of this disclosure.

FIG. 2 is a perspective view of the optical component carrier of FIG. 1.

FIG. 3A is a perspective view of the waveguide carrier of FIG. 1.

FIG. 3B is a front view of the waveguide carrier of FIGS. 1 and 3A.

FIG. 3C is a side cross-sectional view of the waveguide carrier of FIGS. 1, 3A, and 3B.

FIG. 4 is a perspective view of the interconnect of FIG. 1 including the waveguide carrier of FIGS. 1 and 3A-3C and the optical component carrier of FIGS. 1-2.

FIG. 5 is a perspective view of another optical component carrier that can be used in conjunction with the system of FIG. 1.

FIG. 6 is a front view of another waveguide carrier that can be used in conjunction with the system of FIG. 1.

FIG. 7 is a flowchart representative of example operations that can be used to assemble the interconnect of FIGS. 1 and 4.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

As used herein, the orientation of features is described with reference to a lateral axis, a vertical axis, and a longitudinal axis of an optical interconnect including an array of waveguides. As used herein, the longitudinal axis is parallel to a major axis of the waveguides of the optical interconnect (e.g., the direction along which the light signal flows within the waveguide carrier, the major axis of the cylinder defined by the waveguide carrier, etc.). As used herein, the lateral axis is perpendicular to the longitudinal axis and is disposed in the plane in which the waveguides of the waveguide array are disposed. As used herein, the vertical axis is perpendicular to the longitudinal and lateral axes. In general, the attached figures are annotated with a set of axes including the longitudinal axis X, the lateral axis Y, and the vertical axis Z.

In recent years, data centers have increasingly utilized optical compute interconnects (OCI) and co-packaged optics (CPO) for the transmission of signals due to significantly greater bandwidth and speed offered by optical interconnects and processors including photonic integrated circuits (PIC) and electronic integrated circuits (EIC) when compared to electrical interconnects. Additionally, optical connections use comparatively less power than electrical connections, can transmit longer distance without signal deterioration and are not susceptible to electromagnetic interference from other electrical components. Many prior pluggable transceiver systems include connectors that have a plurality of waveguides, which enables multi-wavelength and/or multi-channel communication. Some prior systems include a separate Tx (transceiver) PIC and a Rx (receiver) PIC. The bandwidth provided by these prior configurations are not sufficient for some AI compute systems and datacenter. In some examples, these prior CPO systems include fiber attachment portions that include fiber ribbons that include multiple optical fibers closely packed together in a single plane. As used herein, the term “waveguide” refers to any structure that guides a light signal from one location to another. One type of waveguide is optical fibers, which are flexible transparent fibers that transmit light via internal reflection. Optical fibers typically include a small core of several micrometer within a cladding of tens to hundreds of micrometer, which called is referred to herein as a “bare fiber”. The bare fibers of some optical fibers are coated with claddings and/or jackets to facilitate to protect the fiber from damage. As used herein, the terms “fiber” and “optical fiber” are used interchangeably. As used herein, the end of a waveguide is interchangeably referred to as a “facet” and an “end.”

To enable the transmission of signals from a PIC via a fiber array, the ends of the waveguides of the optical fiber array block (OFAB) must be precisely aligned with the emitters and/or detectors of the PIC. For example, misalignments between the ends of the waveguides of the fiber array block and the ends (e.g., the end facets, etc.) of the emitters and/or detectors of the PIC of greater than one microns (μm) can significantly degrade signal integrity. Prior PICs include a plurality of grooves that receive the loose individual optical bare fibers of a ribbon cable. Some such prior PICs include an epoxy that couples the optical fibers to the V-grooves. Some such prior configuration and design include a glass lid, which is attached, via epoxy, to retain the optical bare fibers to the grooves. The use of epoxy to couple the optical fibers to the V-grooves and the glass lid to the PIC can cause the flow of epoxy into the space between the fiber waveguide end and the ends of the optical components of the PIC (e.g., emitters, detectors, etc.). The unexpected presence of epoxy particles between the PIC and the waveguide end can cause significant signal losses.

Prior fiber to V-groove configuration connections pose additional challenges. For example, the use of fiber ribbons (e.g., arrays of individual fibers, etc.) can make maintaining consistent facet lengths difficult, labor-intensive and/or costly. Differences in fiber facet lengths at the loose bare fiber among the fibers of a fiber ribbon of greater than 5 microns can result in signal loss, a lack of uniformity in performance among the fibers of the fiber ribbon, and a degradation of signal quality and reliability. Additionally, the simultaneous and precise alignment of each of the optical fibers with the ends of each optical component waveguides (e.g., emitter waveguide, detector waveguide, etc.) of a PIC can be challenging given the small margin for misalignment and the confined space in which a highly integrated CPO are utilized. In some such highly integrated CPOs, PICs are embedded inside other components of the assembly, which can inhibit access to the PIC.

Examples disclosed herein overcome the above-noted challenges. Examples disclosed herein include optical interconnections that include optical component carrier with complimentary V-shaped grooves and waveguide carriers with reverse V-shaped grooves. Examples disclosed herein include an interconnected created by the engagement of the V-shaped grooves of the optical component carrier and the reverse V-shaped grooves of the waveguide carrier. In some examples disclosed herein, the engagement of the V-shaped grooves and the complimentary V-shaped grooves laterally and vertically aligns the optical components of the optical component carriers and the waveguides of the waveguide carriers. Some waveguide carriers disclosed herein include a boss, which is distal to the V-shaped grooves. In some such examples disclosed herein, the boss of the waveguide carrier can engage with a corresponding surface in a cavity of the optical component carrier, which longitudinally aligns the optical components of the optical component carriers and the waveguides of the waveguide carriers. In some such examples disclosed herein, the boss can be coupled to the cavity via a photo-sensitive adhesive. Some examples disclosed herein include waveguide carriers with rails that are to engage with corresponding slots of the optical component carriers.

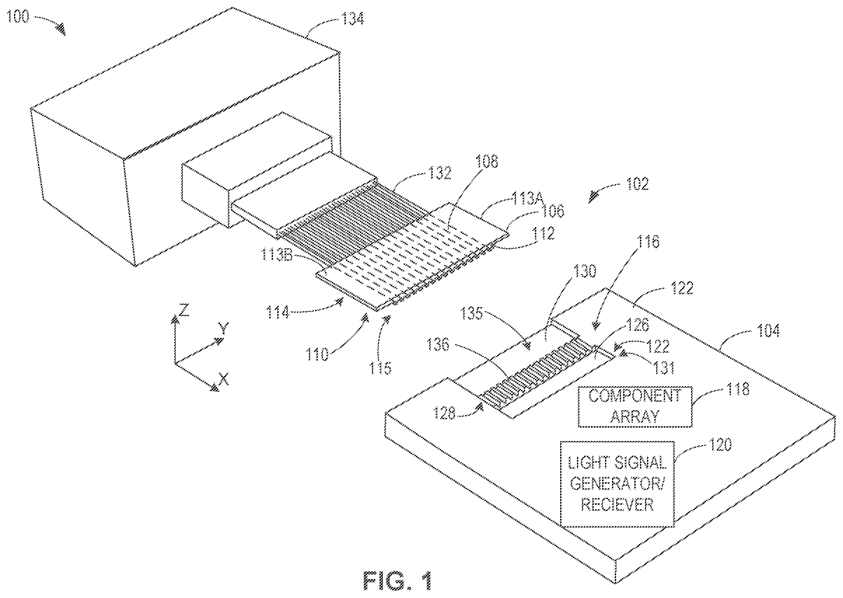

FIG. 1 is a partially exploded perspective view of an example system 100 including an example interconnect 102 between an example photonic integrated circuit (PIC) 104 and an example waveguide carrier 106 implemented in accordance with teachings of this disclosure. In the illustrated example of FIG. 1, the waveguide carrier 106 includes an example body 108, example waveguide grooves 110, example first lateral face 112, an example first wing 113A, an example second wing 113B, and an example waveguide array 114. In the illustrated example of FIG. 1, the waveguides of the waveguide array 114 includes example waveguide ends 115. In the illustrated example of FIG. 1, the PIC 104 includes an example optical component carrier 116, an example component array 118, an example laser generator/receiver 120, and an example top surface 122. In the illustrated example of FIG. 1, the optical component carrier 116 includes an example first trench 126, example carrier grooves 128, and an example second trench 130. In the illustrated example of FIG. 1, the component array 118 includes example component ends 131. In the illustrated example of FIG. 1, the waveguide carrier 106 is coupled to an example ribbon 132, which extends from an example connector 134. In the illustrated example of FIG. 1, the waveguide array 114 extends through the body 108 and is represented via dash lines. It should be appreciated that the dashed lines are included for visual clarity only and, in some examples, the waveguide array 114 is obstructed by the body 108 of the waveguide carrier 106.

The PIC 104 of this example is a photonic integrated circuit (e.g., a chip, etc.) that generates and/or processes light signals (e.g., photons, etc.). In the illustrated example of FIG. 1, the PIC 104 includes the light signal generator/receiver 120, which generates, receives, and/or transmits light signals. In some examples, the light signal generator/receiver 120 transmits and/or receives light signals through the component array 118. In some examples, the component array 118 is emitter array (e.g., includes a plurality of emitters that output light signals generated by the light signal generator/receiver 120, etc.), a detector array (e.g., includes a plurality of detectors that receive light transmitted via the waveguide carrier 106, etc.), and/or a hybrid array (e.g., includes both detectors and emitters, etc.). In some examples, the component array 118 can include an array of waveguides that direct light to the components (e.g., the detectors, emitters, etc.). In some examples, the PIC 104 includes one or more additional components for the detecting, processing, and/or generating of light signals. In some examples, the PIC 104 can include components that modify a property of the light signal. For example, the PIC 104 can include one or more interfaces (e.g., wired interfaces, wireless interfaces, etc.) to an electronic integrated circuit (EIC). Additionally or alternatively, the PIC 104 can include one or more structures to receive data, one or more transducers, one or more modulators, one or more photodiodes, one or more memories, one or more other interfaces, and/or other components. The light signals are modulated to convey data corresponding to the input. In some examples, the PIC 104 is coupled to a baseboard and/or a component of one or more larger compute system(s) (e.g., a server, a computer, a data center, an artificial intelligence (AI) data center, etc.). In some examples, the PIC 104 is a silicon photonic interface circuit (e.g., the PIC 104 includes silicon, etc.). In other examples, the PIC 104 includes lithium niobate and/or another polymer. Additionally or alternatively, the PIC 104 can include one or more structures (e.g., additionally waveguide arrays, etc.) to transmit and/or receive data (e.g., light signals, electrical signals, etc.).

The waveguide carrier 106, also referred to herein as a fiber array block (FAB), is an assembly that includes (e.g., carries, supports, contains, etc.) the waveguide array 114. In the illustrated example of FIG. 1, the waveguide carrier 106 is an integral component (e.g., the body 108, the waveguide grooves 110, the wings 113A, 113B are part of a unitary body, etc.). In some such examples, the waveguide carrier 106 is manufactured from a singular blank via photonic process, etching, machining and/or additively manufactured, etc. In other examples, some or all of the body 108, the waveguide grooves 110, and the wings 113A, 113B are discrete components. For example, one or more components of the waveguide carrier 106 can be coupled via one or more chemical adhesive(s), one or more interference fit(s), one or more weld(s), etc. The waveguide carrier 106 can be composed of any rigid material (e.g., a metal, a composite, a glass, a plastic, etc.). In some examples, the waveguide array 114 can be disposed within the waveguide carrier 106 via one or more adhesives, via mechanical deposition (e.g., a multi-piece mechanical assembly, etc.). In some examples, the waveguide array 114 can include a first portion of fibers adjacent to the ribbon 132 and a second portion of planar lightwave circuit (PLC) waveguides array adjacent to ends 131.

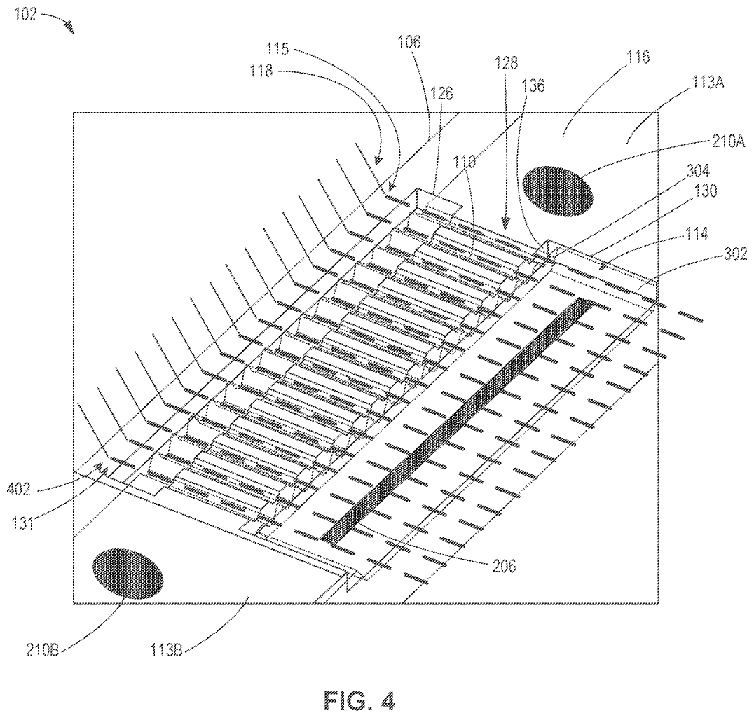

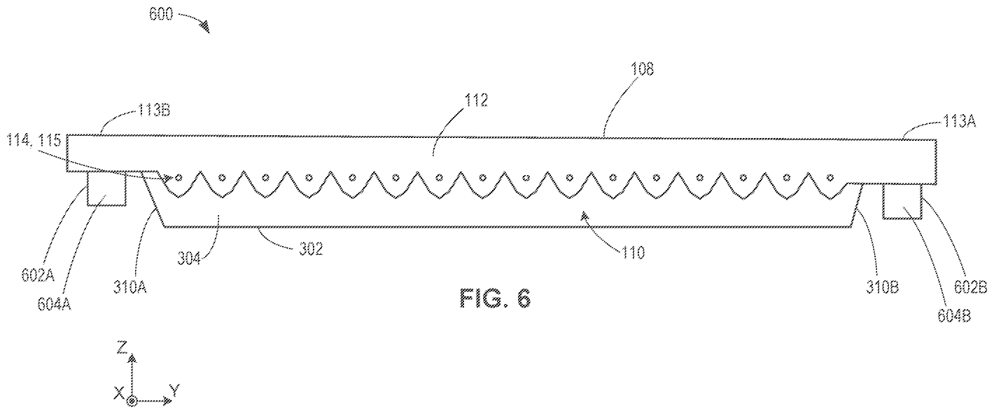

The wings 113A, 113B mechanically support (e.g., mechanically facilitate, etc.) the waveguide carrier 106 and the optical component carrier 116. In some examples, the wings 113A, 113B vertically align the waveguide carrier 106 and the optical component carrier 116. In the illustrated example of FIG. 1, the wings 113A, 113B extend laterally from the body 108 of the waveguide carrier 106. During the coupling of the waveguide carrier 106 and the optical component carrier 116, the wings 113A, 113B can be positioned on the top surface 122 of the optical component carrier 116. In some such examples, the abutment of the wings 113A, 113B and the top surface 122 of the optical component carrier 116 mechanically supports and/or vertically aligns the waveguide ends 115 and the component ends 131. Additionally or alternatively, the wings 113A, 113B can be coupled to the top surface 122 via one or more photo-sensitive chemical adhesives (e.g., epoxy, etc.) to fixedly couple the waveguide carrier 106 to the optical component carrier 116. In some such examples, the wings 113A, 113B are composed of a transparent, translucent, and/or semi-transparent material (e.g., glass, reinforced glass, clear plastic, a transparent ceramic, a composite, etc.) to facilitate the curing of the photo-sensitive chemical adhesives. In other examples, the 113A, 113B can be composed of any other suitable material (e.g., a metal, a ceramic, a composite, a plastic, etc.). An example coupling of the wings 113A, 113B and the optical component carrier 116 via a chemical adhesive is described below in conjunction with FIG. 4. Additionally or alternatively, the waveguide carrier 106 can include one or more rails, which extend from the wings 113A, 113B, and are received by corresponding slots of the optical component carrier 116. An example waveguide carrier including such rails is described below in conjunction with FIG. 6.

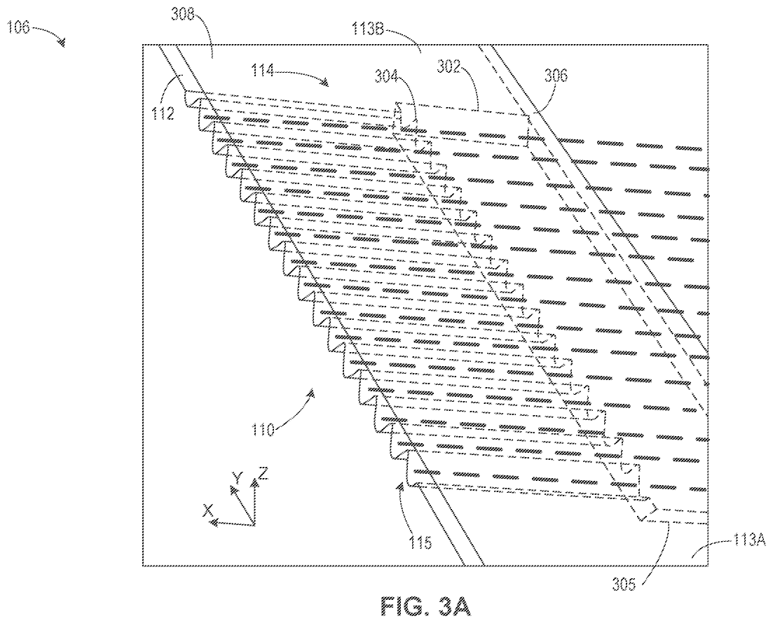

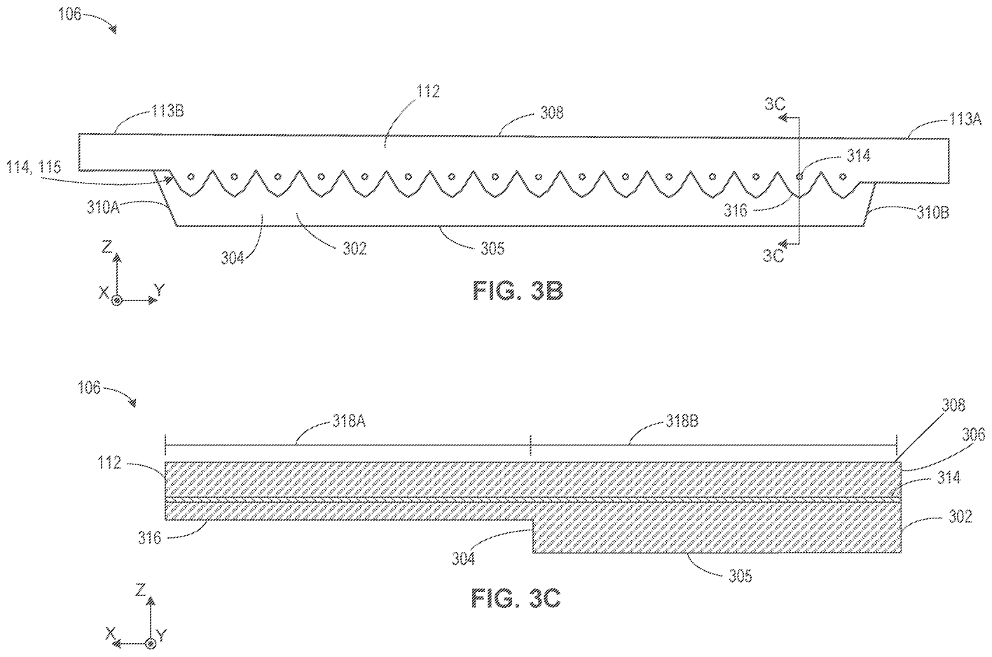

The waveguide grooves 110 of the waveguide carrier 106 facilitate the vertical and lateral alignment of the waveguide ends 115 and the component ends 131. In the illustrated example of FIG. 1, the waveguide grooves 110 of the waveguide carrier 106 extend vertically from the body 108. In the illustrated example of FIG. 1, the waveguide grooves 110 are disposed between the wings 113A, 113B. The waveguide grooves 110 are complimentary to the grooves 128 of the optical component carrier 116. That is, the waveguide grooves 110 are shaped to engage with (e.g., to fit within, to be disposed within, complimentary to, etc.) the grooves 128. As used herein, the waveguide grooves 110 are also referred to as “reverse grooves” because the waveguide grooves 110 are shaped to engage with the grooves 128 of the optical component carrier 116. The waveguide grooves 110 and the waveguide carrier 106 are described in further detail below in conjunction with FIGS. 3A-3C.

The waveguide array 114 extends through the body 108 of the waveguide carrier 106, such that the waveguide ends 115 are substantially flush with the first lateral surface 112. In other examples, the waveguide array 114 can be coupled to a bottom surface of each of the waveguide grooves 110, a center of the body 108, and/or a top surface of the body 108. In some examples, the waveguides of the waveguide array 114 can be integrally with the body 108. For example, the waveguide array 114 can include one or more cylindrical portions (e.g., glass portions, plastic portions, etc.) that have different optical properties than the surrounding features of the body 108. In some such examples, the waveguide carrier 106 is manufactured via photonic processing, etching, planar lightwave circuit (PLC) processing, or one or more additive manufacturing techniques. In other examples, the fibers of the ribbon 132 are inserted through corresponding cavities of the body 108 (e.g., cavities extending through the waveguide grooves 110, etc.), such that the ends of the fibers of the ribbon 132 are substantially flush with the first lateral surface 112. In some examples, the first lateral surface 112 is polished to control the longitudinal position of the ends of the waveguide array 114 (e.g., polished to a tolerance of one micrometer, etc.).

The optical component carrier 116 is a structure that includes (e.g., carries, supports, contains, etc.) the optical components of the component array 118. In the illustrated example of FIG. 1, the optical component carrier 116 includes an example cavity 135 that extends into the top surface 122 of the PIC 104. In other examples, the cavity 135 is absent. In some such examples, the optical component carrier 116 is on a boss that extends vertically from the top surface 122 of the PIC 104 and/or extends from an edge of the PIC 104.

The grooves 128 of the optical component carrier 116 facilitate the alignment of the waveguide carrier 106 and the optical component carrier 116. The grooves 128 are complimentary with the waveguide grooves 110. The first trench 126 is disposed between the component ends 131 and the carrier grooves 128. In some examples, the first trench 126 reduces the likelihood of the flow of adhesive between the waveguide ends 115 and the component ends 131 during the coupling of the waveguide carrier 106 and the optical component carrier 116 (e.g., to maintain an air gap between the waveguide ends 115 and the component ends 131, etc.).

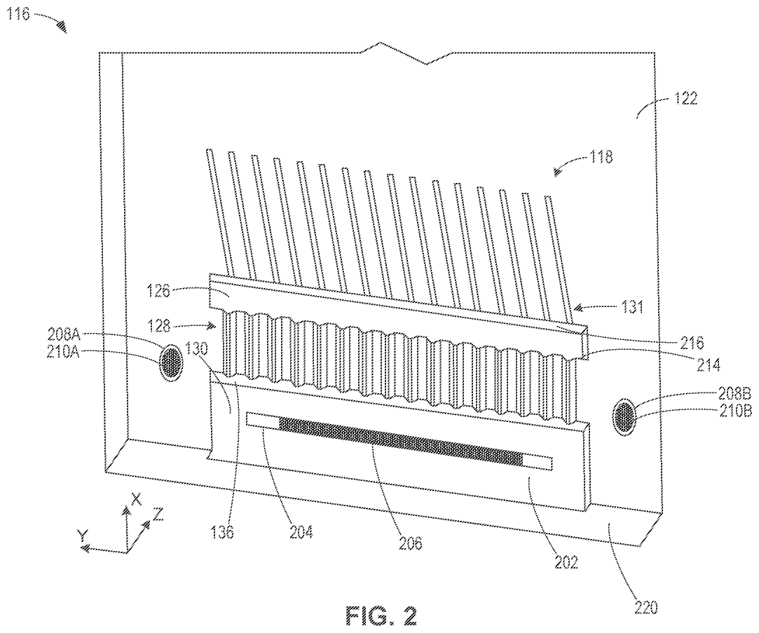

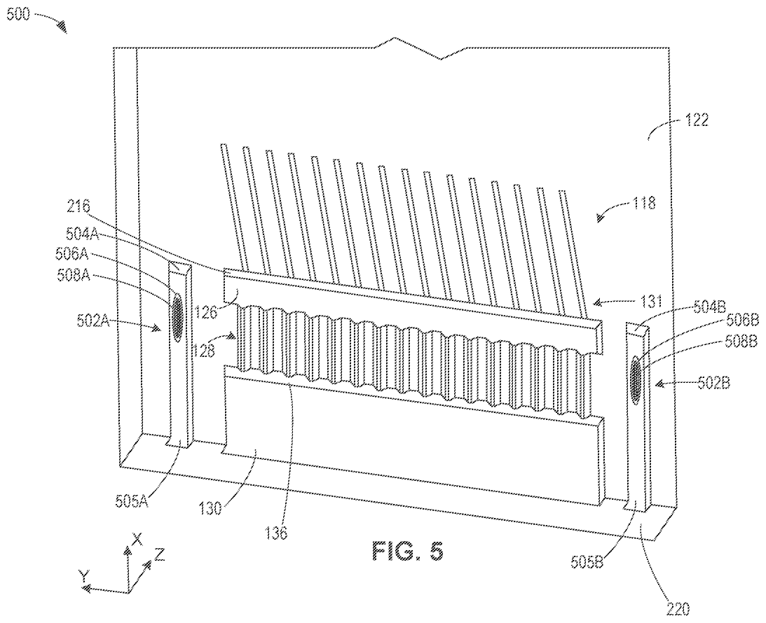

The second trench 130 is adjacent to the carrier grooves 128 (e.g., the carrier grooves 128 are disposed between the trenches 126, 130, etc.). In some examples, the second trench 130 (e.g., an example stop surface 136 of the second trench 130, etc.) engages with a corresponding feature of the waveguide carrier 106 to facilitate the longitudinal alignment of the waveguide ends 115 and the component ends 131. In some examples, one or both of the trenches 126, 130 are absent. As used herein, the term “stop surface” is used interchangeably with “stop” to refer to a portion of a component that prevents further translation of another component in a particular direction. The optical component carrier 116 is described in additional detail below in conjunction with FIG. 2. An example interface between the optical component carrier 116 and the waveguide carrier 106 is described below in conjunction with FIG. 4. In some examples, the optical component carrier 116 can include example slots to facilitate the longitudinal alignment of the waveguide carrier 106. An example optical component carrier including slots is described below in conjunction with FIG. 5.

The component array 118 outputs and/or receives light signals (e.g., photons, light pulses, etc.) generated by the light signal generator/receiver 120 of the PIC 104. For example, the components of the component array 118 can output a corresponding light signal that for transmission a corresponding waveguide of the waveguide array 114 and a corresponding fiber of the ribbon 132. Additionally or alternatively, the components of the component array 118 can receive a corresponding light signal from a corresponding waveguide of the waveguide array 114. In some examples, the component(s) of the component array 118 are implemented via modulated lasers, such as vertical cavity surface-emitting lasers (VESEL), a diode laser, etc. In other examples, the component array 118 includes one or more other suitable light-emitting device(s) and/or light-receiving device(s). In the illustrated example of FIG. 1, the component ends 131 of the component array 118 are disposed at rear of the first trench 126.

In the illustrated example of FIG. 1, light signals received by the waveguide array 114 of the waveguide carrier 106 are transmitted to the ribbon 132. In some examples, the waveguides of the waveguide array 114 are coupled to the waveguides of the ribbon 132 via an index matching epoxy (IME), via direct contact, via a mechanical splice, via a sleeve, via a ferrule, etc. In some examples, the waveguide array 114 can include a splice between the fibers of the ribbon 132 and another type of waveguide within the waveguide carrier 106. In other examples, the waveguides of the ribbon 132 are integral (e.g., continuous, etc.) with the waveguides of the waveguide carrier 106. In the illustrated example of FIG. 1, the ribbon 132 is an array of optical fibers. In other examples, the ribbon 132 can include one or more other types of optical waveguides (e.g., a dielectric waveguide, etc.).

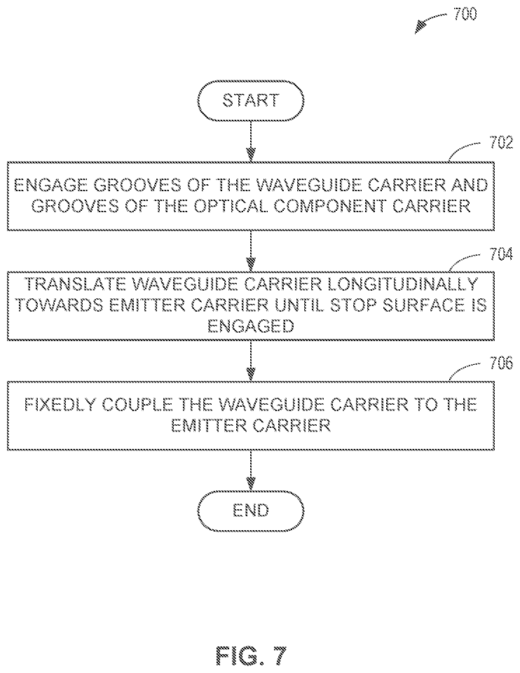

The interconnect 102 communicatively couples the waveguide carrier 106 and the optical component carrier 116. The interconnect 102 is assembled by the engagement of the waveguide grooves 110 of the waveguide array 114 and the grooves 128 of the optical component carrier 116. To assemble the interconnect 102, the waveguide carrier 106 can be positioned such that the waveguide grooves 110 of the waveguide array 114 are engaged with the carrier grooves 128 of the optical component carrier 116. In some examples, the positioning of the waveguide grooves 110 in the carrier grooves 128 (e.g., the engagement of the grooves 110, 128, etc.), laterally and vertically aligns the waveguide ends 115 and the component ends 131. In some examples, the engagement of the grooves 110, 128 causes the wings 113A, 113B to engage (e.g., contact, abut, etc.) the top surface 122 of the optical component carrier 116. After the positioning of the waveguide grooves 110 in the carrier grooves 128, the waveguide carrier 106 can be translated longitudinally toward the optical component carrier 116 until a surface of the waveguide carrier 106 abuts a stop surface of the optical component carrier 116. For example, a boss of the waveguide carrier 106 (not visible in FIG. 1, see the boss 302 of FIGS. 3A and 3C, etc.) can engage the stop surface 136 at a rear of the second trench 130 of the optical component carrier 116. The interconnect 102 of FIG. 1 is described in further detail below in conjunction with FIG. 4. Example operations to assemble the interconnect 102 are described below in conjunction with FIG. 7.

FIG. 2 is a perspective view of the optical component carrier 116 of FIG. 1. In the illustrated example of FIG. 2, the optical component carrier 116 includes the component array 118 of FIG. 1, the top surface 122 of FIG. 1, the first trench 126 of FIG. 1, the carrier grooves 128 of FIG. 1, the second trench 130 of FIG. 1, and the component ends 131 of FIG. 1. In the illustrated example of FIG. 2, the second trench 130 includes an example bottom surface 202 and the stop surface 136 of FIG. 1. In the illustrated example of FIG. 2, the optical component carrier 116 includes an example slot 204, an example first adhesive 206 in the slot 204, an example first pocket 208A, an example second pocket 208B, and an example second adhesive 210A in the second pocket 208B.

In the illustrated example of FIG. 2, the grooves 128 extend parallel to the longitudinal axis. In the illustrated example of FIG. 2, the carrier grooves 128 have open longitudinal ends at an example first wall 214 of the first trench 126 and the stop surface 136 of the second trench 130. In the illustrated example of FIG. 2, the component ends 131 are flush with an example second wall 216. In some examples, the first trench 126 is absent. In some such examples, the grooves 128 extend to the second wall 216 and/or the component ends 131.

In the illustrated example of FIG. 2, the grooves 128 are symmetrical V-shaped grooves. In the illustrated example of FIG. 2, the grooves 128 are integrated into the top surface 122 (e.g., the grooves 128 are integrated grooves, etc.). In other examples, the grooves 128 have other suitable geometrie(s) that is/are complimentary with the waveguide grooves 110 of FIG. 1 (e.g., round grooves, asymmetrical grooves, square grooves, etc.). In the illustrated example of FIG. 2, the carrier grooves 128 include 16 grooves. In other examples, the carriers groove 128 can include any suitable number of grooves (e.g., at least four grooves, at least ten grooves, 12 grooves, 24 grooves, 32 grooves, 64 groove etc.). In the illustrated example of FIG. 2, each of the carrier grooves 128 has a same geometry (e.g., a uniform geometry, etc.) and exhibit uniform spacing (e.g., the carrier grooves 128 are evenly distributed, the carrier grooves 128 have a substantially equal pitch, etc.). In other examples, the carrier grooves 128 have non-uniform geometries and/or non-uniform spacing.

The first trench 126 is longitudinally between the component ends 131 and the carrier grooves 128. The first trench 126 reduces the likelihood of the adhesives 206, 210A, 210B flowing between the ends 115, 131, which could block (e.g., fully block, partially block, etc.) the component ends 131 and the transmission of light from the component array 118. Additionally or alternatively, an index matching epoxy (IME) can be disposed in the trench 126 to create an epoxy gap between the ends 115, 131 (e.g., instead of an air gap, etc.). In other examples, the first trench 126 is absent. In some such examples, the carrier grooves 128 extend continuously to the component ends 131 (e.g., the carrier grooves 128 can extend through the portion of the optical component carrier 116 associated with the first trench 126, etc.). In other such examples, the portion of the optical component carrier 116 corresponding to the first trench 126 is flush with the top surface 122.

The second trench 130 is disposed between an example lateral edge 220 of the optical component carrier 116 (e.g., a lateral edge of the PIC 104, etc.) and the carrier grooves 128. In the illustrated example of FIG. 1, the bottom surface 202 of the second trench 130 extends from the stop surface 136 to the lateral edge 220, which enables the optical component carrier 116 to receive a corresponding feature of the waveguide carrier 106 of FIG. 1 (e.g., the boss 302 of FIGS. 3A-3C, etc.). In some examples, the bottom surface 202 and the stop surface 136 facilitate the longitudinal alignment of the waveguide carrier 106 of FIG. 1 and the optical component carrier 116. In some such examples, the stop surface 136 can interface with a corresponding feature of a waveguide carrier to inhibit the longitudinal translation of the waveguide carrier 106 beyond a longitudinally aligned position of the waveguide ends 115 of FIG. 1 and the component ends 131. In the illustrated example of FIG. 2, the first trench 126 and the second trench 130 have a substantially equal vertical length (e.g., a substantially the same depth, etc.). In other examples, the first trench 126 and the second trench 130 can have different vertical lengths (e.g., the first trench 126 is shallower the second trench 130, the second trench 130 is shallower than the first trench 126, etc.).

The slot 204 is a cavity (e.g., blind holes, etc.) in the bottom surface 202 of the second trench 130. The pockets 208A, 208B are cavities (e.g., blind holes, etc.) in the top surface 122 of the optical component carrier 116. In the illustrated example of FIG. 2, the pockets 208A, 208B are laterally displaced from the slot 204 and are disposed on opposite sides of the second trench 130. In some examples, the triangular arrangement of the pockets 208A, 208B and the slot 204 increases the mechanical stability of the connection between the interconnect 102. In other examples, the pockets 208A, 208B are at other locations on the top surface 122 (e.g., laterally aligned with the carrier grooves 128, laterally aligned with the first trench 126, etc.). In the illustrated example of FIG. 2, the pockets 208A, 208B are generally oval-shaped (e.g., ovoid, etc.) and the slot 204 is generally rectangular-shaped. In other examples, the slot 204 and the pockets 208A, 208B can have any other suitable shape (e.g., other polygon(s), circle(s), etc.).

Prior to the alignment of the waveguide carrier 106 of FIG. 1 and the optical component carrier 116 via the engagement of the waveguide carrier 106 and the grooves 128, the adhesives 206, 210A, 210B (e.g., a photo-sensitive adhesive, etc.) can be disposed in the slot 204, the first pockets 208A and the second pocket 208B, respectively. In some examples, if the adhesives 206, 210A, 210B are photo-sensitive, after alignment of the waveguide carrier 106 and the optical component carrier 116, ultraviolet (UV) light can be applied to the interconnect 102 to cause the adhesives 210A, 210B to flow and bond the waveguide carrier 106 of FIG. 1 to the optical component carrier 116. In some such examples, the waveguide carrier 106 includes a material that is permeable to UV radiation (e.g., glass, plastics, etc.). In other examples, the adhesives 206, 210A, 210B can be implemented by one or more heat-curing adhesive(s) and/or moisture-curing adhesive(s). In the illustrated example of FIG. 2, the adhesives 206, 210A, 210B are distal to the component ends 131. That is, the first adhesive 206 is disposed in the second trench 130 and the adhesives 210A, 210B are disposed on the top surface 122 and, as such, the adhesives 206, 210A, 210B longitudinally and laterally displaced from the component ends 131. Accordingly, the placement of the adhesives 206, 210A, 210B decreases the likelihood of adhesive flowing between the component ends 131 and the waveguide ends 115 of FIG. 1. In some examples, an index matching epoxy (IME) can be deposited between the component ends 131 and the waveguide ends 115.

FIG. 3A is a perspective view of the waveguide carrier 106 of FIG. 1. FIG. 3B is a front view of the waveguide carrier 106 of FIGS. 1 and 3A. In the illustrated examples of FIGS. 3A and 3B, the waveguide carrier 106 includes the example waveguide grooves 110 of FIG. 1, the first lateral surface 112 of FIG. 1, the wings 113A, 113B of FIG. 13, the waveguide array 114 of FIG. 1, the waveguide ends 115 of FIG. 1, an example boss 302, an example second lateral surface 304, an example bottom surface 305, an example third lateral surface 306, and an example top surface 308. In the illustrated example of FIG. 3A, portions of the boss 302 that are obstructed by the body 108 are depicted via low-weight dashed lines and portions of the waveguide array obstructed by the body 108 are depicted via high-weight dashed lines.

In the illustrated example of FIGS. 3A and 3B, the waveguide grooves 110 are symmetrical V-shaped grooves. In other examples, the waveguide grooves 110 can have any other suitable geometry that is complimentary with the grooves 128 of FIGS. 1 and 2 (e.g., round grooves, asymmetrical grooves, square grooves, etc.). That is, the waveguide grooves 110 can have shapes that facilitate the deposition of the waveguide grooves 110 within the grooves 128. In the illustrated example of FIGS. 3A and 3B, each of the waveguide grooves 110 has a same geometry (e.g., a uniform geometry, etc.) and exhibit uniform spacing (e.g., the waveguide grooves 110 are evenly distributed, the waveguide grooves 110 have a substantially equal pitch, etc.). In some examples, the waveguide grooves 110 are fully seated within the grooves 128 (e.g., the entire perimeter of each groove of the waveguide groove 110 abuts a corresponding entire perimeter of one of the carrier grooves 128, etc.). In other examples, a small gap is formed between the bottom surfaces of the waveguide grooves 110 and the carrier grooves 128. In other examples, the waveguide grooves 110 have non-uniform geometries and/or non-uniform spacing (e.g., depending on the geometry of the grooves 128, etc.). In the illustrated example of FIGS. 3A and 3B, the waveguide grooves 110 include 16 grooves. In other examples, the waveguide grooves 110 can include any suitable number of grooves (e.g., at least four grooves, at least 12 grooves, at least 24 grooves, at least 32 grooves, at least 64 grooves etc.).

In the illustrated example of FIG. 3A, the waveguide grooves 110 extend from the second lateral surface 304 (e.g., from the boss 302, etc.) to the first lateral surface 112. In other examples, if the boss 302 is absent, the waveguide grooves 110 along an entire longitudinal length of the waveguide carrier 106. The relationship between the waveguide grooves 110 and the boss 302 is described in additional detail below in conjunction with FIG. 3C.

In the illustrated example of FIG. 3A, each waveguide of the waveguide array 114 extends through longitudinally through the third lateral surface 306, through the boss 302 and through a corresponding of the waveguide grooves 110, such that the waveguide ends 115 are substantially flush with the first lateral surface 112. In other examples, the waveguide array 114 can be disposed on the top surface 308 of the waveguide carrier 106, between individual ones of the waveguide grooves 110, and/or beneath the crests of individual ones of the waveguide grooves 110.

The boss 302 facilitates the longitudinal alignment of the waveguide carrier 106 and the optical component carrier 116. For example, the second lateral surface 304 can engage with (e.g., come into contact, abut, etc.) a corresponding feature of the optical component carrier 116 (e.g., the stop surface 136 of FIGS. 1 and 2, etc.) to prevent further longitudinal translation of the waveguide carrier 106 after the alignment of the waveguide ends 115 and the component ends 131 of FIGS. 1 and 3. In the illustrated example of FIGS. 3A and 3B, the boss 302 extends vertically from the body 108 in a direction parallel to the waveguide grooves 110. In the illustrated example of FIG. 3B, the bottom surface 305 of the boss 302 is vertically displaced from the waveguide grooves 110 and the wings 113A, 113B. In some examples, the boss 302 is integral with the body 108. In other examples, the boss 302 is a discrete component that is coupled to the body 108 via one or more adhesive(s), one or more fastener(s), via one or more weld(s), etc. In the illustrated example of FIG. 3B, the boss 302 includes an example first side surface 310A and an example second side surface 310B. In the illustrated example of FIG. 3B, the side surfaces 310A, 310B are tapered (e.g., extend at an obtuse angle relative to the body 108, etc.). In other examples, the side surfaces 310A, 310B extend at a right angle relative to the body 108.

FIG. 3C is a side cross-sectional view of the waveguide carrier 106 of FIGS. 1, 3A, and 3B taken along the 3C-3C cross-sectional line of FIG. 3B. In the illustrated example of FIG. 3C, the waveguide carrier 106 includes a waveguide 314 of the waveguide array 114 of FIGS. 1, 3A, and 3B and an example groove 316 of the waveguide grooves 110. In the illustrated example of FIG. 3A, the groove 316 has an example first length 318A and the boss 302 has an example second length 318B.

In the illustrated example of FIG. 3C, the waveguide 314 extends continuously from the first lateral surface 112 and the third lateral surface 306. In the illustrated example of FIG. 3C, the waveguide 314 extends parallel to the longitudinal axis. In the illustrated example of FIG. 3C, the first groove 316 extends from the first lateral surface 112 to the second lateral surface 304 of the boss 302. In other examples, an end of the first groove 316 can be spaced from the second lateral surface 304 (e.g., the waveguide carrier 106 includes a gap between the first groove 316 and the boss 302, etc.). In other examples, the interconnect 102 can include other stop surfaces. In the illustrated example of FIG. 3C, the first length 318A and the second length 318B are substantially equal. That is, in the illustrated example of FIG. 3C, the boss 302 has a same longitudinal length as the first groove 316. In other examples, the lengths 318A, 318B are different. For example, the first length 318A can be greater than the second length 318B or the second length 318B can be greater than the first length 318A. In some examples, each of the waveguide grooves 110 has the length 318A. In other examples, the waveguide grooves 110 can have different length(s). For example, the waveguide grooves 110 and the second lateral surface 304 can be angled relative to the lateral axis. In some such examples, the stop surface 136 of the second trench 130 of FIG. 2 is correspondingly angled to receive the second lateral surface 304 and the boss 302.

FIG. 4 is a perspective view of the interconnect 102 of FIG. 1 including the waveguide carrier 106 of FIGS. 1 and 3A-3C and the optical component carrier 116 of FIGS. 1-2. In the illustrated example of FIG. 4, the waveguide carrier 106 includes the waveguide array 114 of FIGS. 1 and 3A-3C, the waveguide grooves 110 of FIGS. 1 and 3B, the wings 113A, 113B of FIGS. 1, 3A, and 3B, the waveguide array 114 of FIG. 1, the boss 302 of FIGS. 3A and 3B, and the second lateral surface 304 of FIGS. 3A and 3B. In the illustrated example of FIG. 4, the optical component carrier 116 includes the component array 118 of FIGS. 1 and 2, the first trench 126 of FIGS. 1 and 2, the carrier grooves 128 of FIGS. 1 and 2, the lateral surface 136 of FIGS. 1 and 2, and the adhesives 206, 210A, 210B of FIG. 2. In the illustrated example of FIG. 4, the features of the waveguide carrier 106 are depicted via dashed lines and the features of the optical component carrier 116 are depicted via solid lines. It should be appreciated that dashed lines are included for visual clarity only.

In the illustrated example of FIG. 4, the waveguide grooves 110 are engaged with (e.g., abutting, disposed in, positioned in, in contact with, etc.) the grooves 128 of the optical component carrier 116. That is, each of the waveguide grooves 110 is disposed within a corresponding one of the carrier grooves 128, such that each of the waveguide ends 115 is vertically and laterally aligned with a corresponding one of the component ends 131. That is, the engagement of the grooves 110, 128 inhibits (e.g., prevents, etc.) the relative lateral and vertical translation of the waveguide carrier 106 and the optical component carrier 116.

In the illustrated example of FIG. 4, the engagement of the stop surface 136 of the second trench 130 and the second lateral surface 304 of the boss 302 longitudinally aligns the waveguide ends 115 and the component ends 131. That is, the engagement of the boss 302 and the second trench 130 inhibits (e.g., prevents, etc.) the relative longitudinal translation of the waveguide carrier 106 and the optical component carrier 116. As such, the interconnect 102 laterally, longitudinally, and vertically aligns the waveguide ends 115 and the component ends 131 via the engagement of (1) the grooves 110, 128 and (2) the boss 302 and the lateral surface 136. The alignment of the component ends 131 and the waveguide ends 115 enables the transmission of light signals from the component array 118 through the waveguide array 114.

In the illustrated example of FIG. 4, the interconnection 102 includes an example gap 402 between the waveguide ends 115 of the waveguide carrier 106 and the component ends 131 of the optical component carrier 116. In some examples, an index-matching material is disposed in the gap 402. In some such examples, the index matching material has an index of refraction that is similar to the index of refraction of the waveguides of the waveguide array 114 to facilitate the transmission of light signals from the component array 118 to the waveguide array 114. In some examples, the index matching material can be a gel, an adhesive (e.g., an epoxy, etc.), and/or another suitable material. In some examples, the index matching material can be disposed the gap 402 when the adhesives 206, 210A, 210A are disposed on the optical component carrier 116. In other examples, the gap 402 does not include an index matching epoxy (IME) (e.g., the gap 402 is an air gap, etc.).

In the illustrated example of FIG. 4, the interconnect 102 includes 16 pairs of ones of the waveguide arrays 114 and the component array 118 (e.g., the waveguide array 114 includes 16 waveguides, the component array 118 includes 16 optical components respectively aligned with the waveguides, etc.). In other examples, the interconnect 102 includes any other suitable number of pairs of waveguides and optical components (e.g., one pair, two pairs, four pairs, 8 pairs, 12 pairs, 16 pairs, 32 pairs, 50 pairs, 64 pairs etc.). In the illustrated example of FIG. 2, the components of the component array 118 are angled relative to the longitudinal axis and the major axis of the waveguide carriers of the waveguide array 114 to facilitate the transmission of light between the component array 118 and the waveguide array 114. It should be appreciated that the angle of the components of the component array 118 may be exaggerated in the illustrated example of FIG. 4 and, in other examples, could be parallel and/or refracted via the faceting of the waveguides of the waveguide carrier 106.

FIG. 5 is a perspective view of another optical component carrier 500 that can be used in conjunction with the system of FIG. 1. The optical component carrier 500 is similar to the optical component carrier 116 of FIGS. 1, 2, and 4, except that the optical component carrier 500 includes an example first slot 502A, an example second slot 502B, and as otherwise noted. In the illustrated example of FIG. 5, the optical component carrier 500 includes the example top surface 122 of FIGS. 1 and 2, the example first trench 126 of FIGS. 1 and 2, the example carrier grooves 128 of FIGS. 1 and 2, the component ends 131 of FIGS. 1 and 2, the example second trench 130 of FIGS. 1 and 2, and the stop surface 136 of FIGS. 1 and 2. In the illustrated example of FIG. 5, the slots 502A, 502B include an example first stop surface 504A and an example second stop surface 504B, respectively. In the illustrated example of FIG. 5, the slots 502A, 502B include an example first receiving surface 505A and an example second receiving surface 505B.

The slots 502A, 502B extend vertically from the top surface 122 into the body of the optical component carrier 116. For example, the slots can extend (e.g., ten microns, 20 microns, 100 microns, 400 microns, etc.) into the top surface 122 of the optical component carrier 116. In other examples, the slots 502A, 502B can have any other suitable dimensions (e.g., a same vertical length as the second trench 130, a same vertical length as the first trench 126, etc.). The slots 502A, 502B enable the optical component carrier 500 to receive the corresponding features of a waveguide carrier of FIG. 1 (see the rails 602A, 602B of FIG. 6, etc.). In some examples, the stop surfaces 504A, 504B inhibit the longitudinal translation of a waveguide carrier beyond a longitudinally aligned position of the component ends 131 and corresponding waveguide ends (e.g., the waveguide ends 115 of FIG. 1, etc.). While the optical component carrier 500 includes the second trench 130, in some examples, the second trench 130 is absent. In some such examples, the longitudinal alignment of the component ends 131 and the corresponding waveguide ends (e.g., the waveguide ends 115 of FIGS. 1, 3A, and 3B, etc.) is facilitated by the engagement of the stop surfaces 504A, 504B and corresponding features of a waveguide carrier. An example waveguide carrier that includes features that engage with the slots 502A, 502B is described below in conjunction with FIG. 6.

In the illustrated example of FIG. 5, the carrier grooves 128, and the second trench 130 are disposed between the first slot 502A and the second slot 502B. In the illustrated example of FIG. 5, the stop surfaces 504A, 504B are longitudinally aligned with the second wall 216 of the first trench 126. In other examples, the stop surface 504A, 504B have other lateral position(s). In some examples, the stop surfaces 504A, 504B are perpendicular, tapered, chambered, and/or filleted relative to the receiving surfaces 505A, 505B, respectively. In some examples, one or both of the slots 502A, 502B are absent. In some such examples, the optical component carrier 500 can include features that extend vertically from the top surface 122 (e.g., rails, bosses, etc.) in a same position as the slots 502A, 502B. In some such examples, the vertical extending features of the optical component carriers 500 can be received by corresponding features in a waveguide carrier similar to the waveguide carrier 106 of FIG. 1.

In the illustrated example of FIG. 5, the slots 502A, 502B of the optical component carrier 500 include an example first pocket 506A and an example second pocket 506B, which include an example first adhesive 508A and an example second adhesive 508B. The pockets 506A, 506B and the adhesives 508A, 508B are similar to the pockets 208A, 208B and the adhesive 210A, 210B of FIG. 2, except that the pockets 506A, 506B are disposed in the slots 502A, 502B. In the illustrated example of FIG. 5, the pockets 506A, 506B are on the receiving surface 505A, 505B, respectively. In other examples, the pockets 506A, 506B and the adhesives 508A, 508B are at another location in the slots 502A, 502B (e.g., the stop surfaces 504A, 504B, one or more of the side walls of the slots 502A, 502B, etc.). Like the adhesives 210A, 210B of FIG. 2, the adhesives 508A, 508B are distal to the component ends 131 and can be cured to fixedly couple the optical component carrier 500 and a waveguide carrier (e.g. the waveguide carrier 106 of FIG. 1, the waveguide carrier 600 of FIG. 6, etc.). Additionally or alternatively, the optical component carrier 500 can include additional pocket(s) and/or adhesive(s) on the top surface 122 (e.g., similar to the pockets 208A, 208B and the adhesives 210A, 210B of FIG. 2, etc.) and/or in the second trench 130 (e.g., similar to the slot 204 and adhesive 206 of FIG. 2, etc.). In some such examples, the pockets 506A, 506B and/or the adhesives 508A, 508B are absent. Additionally or alternatively, the optical component carrier 500 can be coupled to a waveguide carrier via one or more fastener(s), via one or more additional chemical adhesive(s), via one or more weld(s), one or more interference fit(s), etc.

FIG. 6 is a front view of an example waveguide carrier 600 that can be used in conjunction with the system of FIG. 1. The waveguide carrier 600 is similar to the waveguide carrier 106 of FIGS. 1, 3A-4, except that the waveguide carrier 600 includes an example first rail 602A and an example second rail 602B and as otherwise noted. In the illustrated example of FIG. 6, the waveguide carrier 600 includes the waveguide grooves 110 of FIGS. 1, 3A, and 3B, the first lateral surface 112 of FIGS. 1, 3A and 3B, the wings 113A, 113B of FIGS. 1, 3A, and 3B, the waveguide array 114 of FIGS. 1, 3A, and 3B, the waveguide ends 115 of FIGS. 1, 3A, and 3B, the boss 302 of FIGS. 3A-3C, an example second lateral surface 304, the top surface 308 of FIGS. 3A-3C, and the side surfaces 310A, 310B of FIG. 3B. In the illustrated example of FIG. 6, the rails 602A, 602B include an example first end surface 604A and an example second end surface 604B, respectively. As used herein, the end surfaces 604A, 604B are also referred to herein as “ends.”

In the illustrated example of FIG. 6, the rails 602A, 602B extend vertically from the wings 113A, 113B, respectively, in a same direction as the waveguide grooves 110. In the illustrated example of FIG. 6, the boss 302 is between the rails 602A, 602B. That is, in the illustrated example of FIG. 6, the first rail 602A is adjacent to the first side surface 310A and the second side rail 602B is adjacent to the second side surface 310B. In some examples, the end surfaces 604A, 604B of the rails 602A, 602B are substantially longitudinally flush with the second lateral surface 304 of the boss 302. In other examples, one or both of the end surfaces 604A, 604B are longitudinally displaced from the second lateral surface 304 of the boss 302 (e.g., displaced longitudinally toward the first lateral surface 112, displaced longitudinally away from the first lateral surface 112, etc.). In other examples, the boss 302 is absent from the waveguide carrier 600.

The rails 602A, 602B facilitate the longitudinal alignment of the waveguide ends 115 of the waveguide carrier 600 and the corresponding optical component ends of an optical component carrier (e.g., the component ends 131 of the optical component carrier 500 of FIG. 5, etc.). For example, the rails 602A, 602B can be seated within (e.g., positioned within, disposed in, coupled to, etc.) the slots 502A, 502B of the optical component carrier 500 of FIG. 5. In some examples, the engagement of the end surfaces 604A, 604B and the stop surfaces 504A, 504B of the optical component carrier 500 longitudinally align the waveguide ends 115 and the component ends 131. Additionally, the positioning of the waveguide grooves 110 of the waveguide carrier 106 in the grooves 110, 128 of the optical component carrier 500 (e.g., the engagement of the grooves 110, 128, etc.), laterally and vertically aligns the waveguide ends 115 and the component ends 131. As such, an interconnection including the optical component carrier 500 of FIG. 5 and the waveguide carrier 600 of FIG. 6 (e.g., an interconnection similar to the interconnect 102 of FIG. 2, etc.) laterally, longitudinally, and vertically aligns the waveguide ends 115 and the component ends 131.

FIG. 7 is a flowchart representative of example operations 700 that can be used to assemble the interconnect 102 of FIGS. 1 and 4. The example operations 700 are described with reference to the interconnect 102 of FIGS. 1 and 4. However, it should be appreciated the operations 700 can be used to assemble other interconnections disclosed herein. For example, the operations 700 can be used to assemble an interconnection including the optical component carrier 500 of FIG. 5 and the waveguide carrier 600 of FIG. 6.

The operations 700 begin at block 702, at which the waveguide grooves 110 of the waveguide carrier 106 are engaged with the grooves 128 of the optical component carrier 116. For example, the waveguide grooves 110 can be positioned such that the waveguide grooves 110 are engaged with the carrier grooves 128 of the optical component carrier 116. At block 704, the waveguide carrier 106 is longitudinally translated toward the optical component carrier 116 until a stop surface is engaged. For example, the waveguide carrier 106 can be translated until the second lateral surface 304 of the boss 302 of the waveguide carrier 106 engages with the lateral surface 136 of the second trench 130 of the waveguide carrier 106. At block 706, the waveguide carrier 106 is fixedly coupled with the optical component carrier 116. For example, ultraviolet light can be applied to the interconnect 102 to cure the adhesives 210A, 210B and fixedly couple the waveguide carrier 106 and the optical component carrier 116. In other examples, the adhesives 210A, 210B can be cured via the application of heat and/or water. In other examples, the waveguide carrier 106 and the optical component carrier 116 can be coupled in any other suitable manner (e.g., via one or more fasteners, via one or more welds, via one or more solders, via one or more interface fits, etc.).

Although the example operations 700 are described with reference to the flowchart illustrated in FIG. 7, many other methods of assembling an interconnect implemented in accordance with the teachings of this disclosure may alternatively be used. For example, the order of execution of the blocks may be changed, and/or some of the blocks described may be changed, eliminated, or combined.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Optical interconnects and related are disclosed herein. Further examples and combinations thereof include the following:

Example 1 includes an optical interconnect comprising an optical component carrier including first grooves, the optical component carrier including an optical component including a first end, and a waveguide carrier including second grooves engaged with the first grooves, the first grooves complimentary with the second grooves, the waveguide carrier including a waveguide in a corresponding one of the second grooves, the waveguide including a second end aligned with the first end.

Example 2 includes the optical interconnect of any preceding example, wherein the first grooves include a V-shaped groove.

Example 3 includes the optical interconnect of any preceding example, wherein the waveguide carrier further includes a wing extending from a third end of the second grooves.

Example 4 includes the optical interconnect of any preceding example, wherein the waveguide carrier includes a material that is permeable to ultra-violet radiation.

Example 5 includes the optical interconnect of any preceding example, wherein the first grooves include a first side substantially flush with the second end and a second side opposite the first end and the optical component carrier includes a first trench adjacent to the second side.

Example 6 includes the optical interconnect of any preceding example, wherein the waveguide carrier includes a boss, the boss to engaged with a surface of the first trench.

Example 7 includes the optical interconnect of any preceding example, wherein the optical component carrier includes a second trench between the first end and the first side of the first grooves.

Example 8 includes the optical interconnect of any preceding example, wherein the first grooves extend along an axis, the waveguide carrier further includes a rail extending along the axis, and the optical component carrier includes a slot to engage with the rail.

Example 9 includes the optical interconnect of any preceding example, wherein the slot includes a stop and the rail includes an end to engage the stop.

Example 10 includes the optical interconnect of any preceding example, wherein the first grooves exhibit uniform spacing and the first grooves include at least three grooves.

Example 11 includes a waveguide carrier comprising a body including a lateral surface, a plurality of grooves extending vertically from the body, and a first waveguide extending through a first groove of the grooves, the first groove including an end flush with the lateral surface, and a second waveguide extending through a second groove of the grooves.

Example 12 includes the waveguide carrier of any preceding example, further including a first wing extending from the body, and a second wing extending from the body, the grooves disposed between the first wing and the second wing.

Example 13 includes the waveguide carrier of any preceding example, further including a rail extending from the first wing.

Example 14 includes the waveguide carrier of any preceding example, wherein the lateral surface is a first lateral surface, the waveguide carrier includes a boss extending from a body, the boss including the plurality of the grooves extending longitudinally between the first lateral surface and a second lateral surface of the boss.

Example 15 includes the waveguide carrier of any preceding example, wherein the first waveguide extends through the boss.

Example 16 includes the waveguide carrier of any preceding example, wherein the boss includes a bottom surface displaced from the plurality of grooves.

Example 17 includes the waveguide carrier of any preceding example, wherein the plurality of grooves exhibit uniform spacing and the plurality of grooves include at least three grooves.

Example 18 includes a method to assemble an interconnect between a photonic integrated circuit and a waveguide carrier, the method including engaging first grooves of a waveguide carrier and second grooves of an optical component carrier of the photonic integrated circuit, the first grooves complimentary with the second grooves, translating at least one of (1) the waveguide carrier toward the photonic integrated circuit or (2) the photonic integrated circuit toward the waveguide carrier until a stop prevents further translation, and fixedly coupling the waveguide carrier and the optical component carrier.

Example 19 includes the method of any preceding example, wherein the fixedly coupling of the waveguide carrier and the optical component carrier includes curing an adhesive in a pocket of the optical component carrier.

Example 20 includes the method of any preceding example, further including positioning the first grooves in third grooves of the optical component carrier.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An optical interconnect comprising:
an optical component carrier including first grooves, the optical component carrier including an optical component including a first end; and
a waveguide carrier including second grooves engaged with the first grooves, the first grooves complimentary with the second grooves, the waveguide carrier including a waveguide in a corresponding one of the second grooves, the waveguide including a second end aligned with the first end.

2. The optical interconnect of claim 1, wherein the first grooves include a V-shaped groove.

3. The optical interconnect of claim 1, wherein the waveguide carrier further includes a wing extending from a third end of the second grooves.

4. The optical interconnect of claim 3, wherein the waveguide carrier includes a material that is permeable to ultra-violet radiation.

5. The optical interconnect of claim 1, wherein the first grooves include a first side substantially flush with the second end and a second side opposite the first end and the optical component carrier includes a first trench adjacent to the second side.

6. The optical interconnect of claim 5, wherein the waveguide carrier includes a boss, the boss to engaged with a surface of the first trench.

7. The optical interconnect of claim 5, wherein the optical component carrier includes a second trench between the first end and the first side of the first grooves.

8. The optical interconnect of claim 1, wherein the first grooves extend along an axis, the waveguide carrier further includes a rail extending along the axis, and the optical component carrier includes a slot to engage with the rail.

9. The optical interconnect of claim 8, wherein the slot includes a stop and the rail includes an end to engage the stop.

10. The optical interconnect of claim 1, wherein the first grooves exhibit uniform spacing and the first grooves include at least three grooves.

11. A waveguide carrier comprising:
a body including a lateral surface;
a plurality of grooves extending vertically from the body; and
a first waveguide extending through a first groove of the grooves, the first groove including an end flush with the lateral surface; and
a second waveguide extending through a second groove of the grooves.

12. The waveguide carrier of claim 11, further including:
a first wing extending from the body; and
a second wing extending from the body, the grooves disposed between the first wing and the second wing.

13. The waveguide carrier of claim 12, further including a rail extending from the first wing.

14. The waveguide carrier of claim 11, wherein the lateral surface is a first lateral surface, the waveguide carrier includes a boss extending from the body, the boss including the plurality of the grooves extending longitudinally between the first lateral surface and a second lateral surface of the boss.

15. The waveguide carrier of claim 14, wherein the first waveguide extends through the boss.

16. The waveguide carrier of claim 14, wherein the boss includes a bottom surface displaced from the plurality of grooves.

17. The waveguide carrier of claim 11, wherein the plurality of grooves exhibit uniform spacing and the plurality of grooves include at least three grooves.

18. A method to assemble an interconnect between a photonic integrated circuit and a waveguide carrier, the method including:
engaging first grooves of the waveguide carrier and second grooves of an optical component carrier of the photonic integrated circuit, the first grooves complimentary with the second grooves;
translating at least one of (1) the waveguide carrier toward the photonic integrated circuit or (2) the photonic integrated circuit toward the waveguide carrier until a stop prevents further translation; and
fixedly coupling the waveguide carrier and the optical component carrier.

19. The method of claim 18, wherein the fixedly coupling of the waveguide carrier and the optical component carrier includes curing an adhesive in a pocket of the optical component carrier.

20. The method of claim 18, further including positioning the first grooves in third grooves of the optical component carrier.
